(19) United States
(12) Patent Application Publication
(10) Pub. No.: US 2025/0064215 A1
(43) Pub. Date: Feb. 27, 2025

(54) AN OUTDOOR HEATABLE SEAT ASSEMBLY

(71) Applicant: TERMYCA DIGITAL, S.L., ZARAGOZA (ES)

(72) Inventor: FERNANDO BENITO MONREAL, ZARAGOZA (ES)

(21) Appl. No.: 18/724,730

(22) PCT Filed: Dec. 23, 2022
(86) PCT No.: PCT/EP2022/087813

§ 371 Date: Jun. 27, 2024

(30) Foreign Application Priority Data
Dec. 31, 2021 (EP) 21383244.7

(51) Int. Cl. A47C 7/74

(52) U.S. Cl. CPC A47C 7/748

(57) ABSTRACT

A heatable seat assembly including a seat, a support structure supporting the seat and a cover attached to the seat. The heatable seat assembly further includes a heating system to heat the seat, wherein the heating system is arranged between the seat and the cover, a seat controller to control the temperature of the heating system and a detachable power source system to supply power to the heating system. A computer implemented method to control the operation of a plurality of heatable seat assemblies, a computing system having a processor to carry out the computer implemented method and a computer program that causes processor to carry out the computer implemented method are also provided.

The present application claims the benefit and priority of EP21383244.7 filed on Dec. 31, 2021.

The present disclosure relates to heatable seat assemblies and methods and systems for controlling heatable seat assemblies.

### BACKGROUND

Temperature of seats may be controlled to increase the comfort of a user. Some vehicles include heatable or heated car seats to heat the occupant. These heated car seats generally comprise a heating device arranged inside a seat cushion or a seat foam. These heating systems are typically powered by an external power source, e.g. the battery of the vehicle. Outer seat cushions or seat foams are generally not appropriate for an outdoor environment. For instance, the seat cushion or the seat foam may get wet in the rain. The foam or the cushion of the seat absorbs water which may damage the operation of the heating system and makes uncomfortable the experience of the user. In addition, drying these types of seats usually requires a long time.

Heatable benches may be installed in bus or in train stations in cold climate zones. These heatable benches are anchored to the floor and are directly powered by the electrical grid. No batteries are thus employed. These heatable benches provide substantially uniform heat across a long seat surface. Accordingly, heat cannot be adjusted to each person seated on the heatable bench. As the thermal comfort level can vary from person to person, the thermal requirements of some users may not be satisfied with this uniform heat.

In many countries, smoking in closed dining areas is not allowed. For this reason, the number of outdoor dining areas, e.g. bar or restaurant terraces, has greatly increased in recent years. Covid-19 pandemic has accelerated the demand for outdoor zones in hotels and restaurants. Heating lamps may be provided in these outdoor zones of hotels and restaurants to increase the temperature around the users. However, these heating lamps provide uniform heat which may not satisfy the thermal comfort level of all users. In addition, heat received by the users also depends on the distance between the user and the heating lamp.

Current heatable chairs are generally not adapted for outdoor zones, in particular for outdoor zones of hotels and restaurants. The present disclosure provides examples of devices and methods that at least partially resolve some of the aforementioned disadvantages.

### SUMMARY

In a first aspect, an outdoor heatable seat assembly is provided. The outdoor heatable seat assembly comprises a seat having a seat upper surface and a seat lower surface. The seat upper surface is configured to face a body's user when the user is seated on the outdoor heatable seat assembly. The outdoor heatable seat assembly further comprises a support structure supporting the seat and configured to rest on a floor. In addition, the outdoor heatable seat assembly comprises a cover attached to the seat, the cover comprising a cover upper surface and a cover lower surface, wherein the cover upper surface faces the seat lower surface and wherein the cover lower surface is configured to face the floor when the user is seated on the outdoor heatable seat assembly.

The heatable seat assembly further comprises a heating system to heat the seat, wherein the heating system is arranged between the seat lower surface and the cover upper surface and a seat controller to control the temperature of the heating system. In addition, the heatable seat assembly comprises a detachable power source system to supply power to the heating system, wherein the detachable power source system comprises a power source and a power source housing holding the power source. Furthermore, the cover lower surface comprises a cavity to receive the power source housing.

In this disclosure, an outdoor heatable seat assembly shall be understood as a heatable seat assembly specifically designed for being used in an outdoor environment. Outdoor seat assemblies according to this disclosure complies with specific standards and regulations for outdoor furniture and are specifically designed to withstand different external weather conditions during a specific period of time. Outdoor heatable seat assemblies according to this disclosure are thus weatherproof. Accordingly, outdoor heatable seat assemblies according to this disclosure are at least UV-resistant, wind-resistant, temperature-resistant and waterproof. As the outdoor heatable seat assemblies are waterproof, the outdoor heatable seat assemblies according to this disclosure are configured to stay in the rain for long periods without any damage, for example, may withstand the weather conditions for more than one year.

According to this aspect, a seat assembly that can be heated and which is suitable to be used in outdoor zones is provided. Contrary to heating lamps currently used in outdoor zones of hotels and restaurants, different users seated on different heatable seat assemblies may experience different temperatures. The thermal comfort of the users may thus be increased. In addition, the heatable seat assembly according to this aspect may also be used in indoor zones, e.g. in offices.

When a user is seated on the heatable seat assembly, the seat upper surface faces the body of the user and the cover lower surface faces the floor. As the heating system is arranged between the seat and the cover, protection of the heating system against weather conditions, e.g. dust or water, may thus be improved.

Arranging the heating system between the seat and the cover further improves the heating efficiency of the heating system, since thermal losses are reduced. In some examples, the cover upper surface may comprise a thermal insulator material to direct heat towards the seat.

When the seating assembly rests on the floor by the support structure, the cover acts as a lower closure or lower support of the heating system, whereas the seat acts as an upper closure of the heating system. The cover may thus prevent the heating system from falling down. The heating system is thus sandwiched between the seat and the cover.

In some examples, the heating system may be connected to the seat and/or to the cover. For example, the heating system may be attached to the seat lower surface. The seat may provide mechanical resistance to the heating system. The seat may thus act as a support for the heating system. In some examples, the cover upper surface may comprise a depression to receive the heating system. The system heating may thus be fitted into the depression of the cover upper surface.

The heating system is powered by the power source. The power source is housed in the power source housing which can be detached from the seat. Contrary to seat assemblies powered by the electrical grid, the heatable seat assemblies according to this aspect may be moved and arranged at different locations. For example, a heatable seat assembly may be moved from one dining table to another dining table. In addition, as the power source housing can be detached from the heatable seat assembly, the power source may be recharged out of the heatable seat assembly. For example, an external recharger unit may be employed for charging one or more power sources.

The power source housing is received or mounted on the cavity formed in the cover lower surface. The power source housing is thus protected from bumps and scratches and atmosphere elements, e.g. rain and sun. As the cavity to receive the power source housing is arranged out of the seat upper surface, an uncharged power source may be replaced with a charged power source without disturbing a seated user. Mounting the power source housing on the cavity of the cover lower surface may also improve the external appearance of the heatable seat assembly as the power source housing is hidden inside the cover.

In some examples, the seat assembly comprises a back portion or a backrest. In some examples, the seat may extend towards the back portion or backrest, e.g. the back portion may be integral to the seat. In other examples, the cover may extend towards the back portion, e.g. the back portion may be integral to the cover. In further examples, the back portion may be separated from the seat and from the cover.

In some examples, the seat heating assembly comprises a locking mechanism to lock the power source housing onto the cover. The locking mechanism may a locking pin configured to engage and disengage a locking hole for locking the power source onto the seat assembly. In some examples, the locking pin may be arranged at the cover and the locking hole on the power source housing. In other examples, the locking pin may be arranged at the power source housing and the locking pin at the cover, e.g. at a wall defining the cavity. The locking pin may be inserted into the locking hole to retain the power source housing.

In some examples, the locking pin may be manually moved, e.g. up and down or lateral movement. Alternatively, or additionally, the power source may power the locking pin. In some of these examples, the seat controller and/or an external controller may control the movement of the locking pin. Accordingly, the locking pin may be used as an anti-theft system. The locking pin may be remotely controlled. For example, an instruction for unlocking the power source housing may be sent through a NFC protocol.

In some examples, the locking mechanism comprises a driving system to move the locking pin. The driving system may selectively move the locking pin, e.g. from a locking position to an unlocking position. In some examples, the driving system comprises an electromagnet. The electromagnet may be selectively powered to apply a magnetic force against the inner end of the locking pin. This magnetic force causes a linear movement of the locking pin, e.g. from a locking position to an unlocking position. The power source may be used for powering the electromagnet. The seat controller may receive an instruction for unlocking the power source housing and the seat controller may instruct the power source to power the electromagnet.

In some examples, the driving system comprises a deformable element, e.g. a spring, connected to the locking pin and to the electromagnet. The deformable element may limit or control the movement of the locking pin. In some examples, the spring surrounds the locking pin. When the deformable element is in a relaxed position, the locking pin is in a locking position and when the deformable element is in a compressed position, the locking pin is in an unlocking position. When the electromagnet is not powered, pressure may be applied on the outer end of the locking pin to cause a linear movement, e.g. for inserting this outer end in a locking hole.

The cavity of the cover may comprise a recess to receive a protrusion protruding from the power source housing. This protrusion may fit the recess of the cavity. Inserting the protrusion into the recess may collaborate in connecting the power source housing to the cavity.

In some examples, the power source housing comprises a tab element arranged at a first side. The tab element may be configured to apply a pressure against a portion of the wall of the cavity of the cover lower surface or to engage an indentation formed in a wall of the cavity. The power source housing may thus be easily attached to and detached from the cavity of the cover.

In some examples, the power source housing may slide within a portion of the cavity. The insertion and extraction of the power source housing into the cavity may thus be improved.

Contrary to other heatable seats, such as car heatable seats, the seat and/or the cover may be made from a water-resistant material. In some examples, the seat and/or the cover may be made from a plastic material. In some examples, the seat may be made from metal, e.g. aluminum or stainless steel. Protection against water and mechanical resistance of the heatable seat assembly may thus be increased. A seat made from metal enhances the heat transmission from the heating system to the body's user. Furthermore, an aluminum or a stainless-steel seat may improve mechanical resistance while offering good corrosion resistance. A plastic cover also facilitates the connection of the power source housing to the cavity through the tab element. One example of a plastic material may be an injection molded plastic material, e.g. polypropylene.

In some examples, the cover is attached to the seat in a detachable manner. Snap-fits and/or fasteners may be used to attach the cover to the seat. The cover or the seat may thus be detached from the seat to inspect, repair, or replace the heating system. Access to the heating system may thus be improved, while maintaining sufficient protection against external elements such as water or dust. For example, if the cover extends towards a backrest, the seat may be removably attached to the cover to provide easy access to the heating system. Alternatively, if the seat extends towards a backrest, the cover may be removably attached to the seat.

In some examples, the seat controller is configured to regulate the power supplied by the power source to the heating system. For example, the seat controller may adjust a power pattern, e.g. a width of a pulse modulated width (PWM), supplied by the power source to the heating system. Heat experienced by a seated user may thus be precisely adjusted. In some examples, an ON/OFF control may be employed to regulate the power supplied by the power source to the heating system. A regulator, such as a PID controller (proportional-integral-derivative controller) may also be used for regulating the power supplied by the power source.

In some examples, the seat controller may be arranged within the power source housing. Accordingly, both the seat controller and the power source may be detached from the cover. In other examples, the seat controller may be arranged between the seat and the cover.

The seat controller may be further configured to obtain an indication of the temperature of the seat upper surface. For example, the seat controller may receive, from a temperature sensor, an indication of the temperature of the seat upper surface. In addition, the seat controller may receive a temperature setpoint. For example, a seated user may select a temperature setpoint. In other examples, the temperature setpoint may be sent from a computing system to the seat controller. A user interface device may be used by the computing system to receive the temperature setpoint for a specific heatable seat assembly.

A power pattern to be supplied by the power source to the heating system may be determined based on the temperature setpoint and on the indication of the temperature of the seat upper surface. The temperature of the seat upper surface may thus be precisely adjusted in a thermally efficient manner. The power pattern may be defined by for example the width of pulse width modulated power or voltage. For example, modifying the width of the PWM signal may allow controlling the powering time of the heating system. In addition, or alternatively, the power pattern may be defined by ON/OFF times.

In some examples, this power pattern may be determined by the seat controller. However, in other examples, the power pattern may be determined by a computing system which sends the determined power pattern to the seat controller.

In some examples, a seat occupancy may be determined by the seat controller or by the computing system. This may allow controlling the occupancy of a plurality of heatable seat assemblies and, consequently, the occupancy of an outdoor zone of a restaurant or of a hotel. This may improve the control and the management of the restaurant.

In a further aspect, a computer-implemented method to control a temperature of a plurality of heatable seat assemblies is provided. The plurality of heatable seat assemblies may be according to any of the examples herein described.

The computer-implemented method comprises receiving, from a seat controller of a plurality of heatable seat assemblies, an indication of the temperature of a seat upper surface of a seat of each of the plurality of heatable seat assemblies. In addition, a temperature setpoint for each of the plurality of heatable seat assemblies is obtained. The computer-implemented method further comprises determining, for each of the plurality of heatable seat assemblies, a power pattern to be supplied by a power source to a heating system of each of the plurality of heatable seat assemblies, wherein determining the power pattern to be supplied by the power source to the heating system is based on the corresponding temperature setpoint and on the indication of the temperature of the seat upper surface. Then, the corresponding power pattern is sent to the seat controller of each of the plurality of the heatable seat assemblies.

According to this aspect, the operation of a plurality of heatable seat assemblies may be controlled by a computing system, e.g. by a centralized computing system. A single computer, smartphone, tablet, or server may be used to determine the energy to be supplied by each power source to the corresponding heating system to individually adjust the heat provided by the heatable seat assembly to a seated user. This may also allow to switch on the plurality or a group of the plurality of heatable seat assemblies before the users sit on the heatable seat assembly.

In some examples, the computer-implemented method further comprises determining a seat occupancy for each of the plurality of heatable seat assemblies. Overall occupancy of the plurality of heatable seat assemblies may thus be determined. Real-time status of the occupancy of a terrace of a restaurant may thus be obtained. This data may be used for managing the booking process, product orders or even controlling the occupancy time of each table. This data may also be used for statistical purposes.

In some examples, the seat occupancy of a single heatable seat assembly may be obtained by a presence sensor, e.g. arranged on the seat upper surface. In other examples, the seat occupancy for each of the plurality of heatable seat assemblies may be determined by obtaining, for each of the plurality of heatable seat assemblies, a temperature variation of the temperature of the seat upper surface during a predetermined period of time; and comparing, for each of the plurality of heatable seat assemblies, the obtained temperature variation with a predetermined temperature variation. A temperature variation greater than a predetermined temperature variation may indicate that the heatable seat assembly is no longer occupied or that a new user is sat down on the heatable seat assembly.

Furthermore, a seat occupancy time for each of the plurality of heatable seat assemblies may be determined. This may be used to determine the sitting time of a user on a heatable seat assembly and/or the heating time of the heating system. Seat occupancy time may provide data about the occupancy of the restaurant. Furthermore, this data may be used for statistical purposes. In some examples, the seat occupancy time and/or the heating time may be used by the restaurant to charge for the use of the heatable seat assembly. Heating time may also be used to schedule inspection and maintenance operations. Reliability of the heatable seat assemblies may thus be increased. Furthermore, the heating time may be used to determine the power source charge status.

In some examples, the computer-implemented method may comprise obtaining, for each of the plurality of heatable seat assemblies, a heating time of the heating system and/or a power source charge status. In some examples, the power source charge status may be determined from the heating time, e.g. by the seat controller or by a computing system. In further examples, the power source may send a signal to the seat controller or to the computing system containing an indication of the power source charge status. This may be employed to schedule charging the power source without disturbing the user of the heatable seat.

In a further aspect, a computing system comprising a processor configured to perform the computer-implemented method according to any of the examples herein disclosed is provided.

In a yet further aspect, a computing program comprising instructions, which, when the program is executed by a processor, cause the processor to carry out the computer-implemented method to any of the examples herein disclosed is provided.

Advantages derived from these two last aspects may be similar to those mentioned regarding the heatable seat assembly of the first aspect and/or the implemented computer method of the second aspect.

### BRIEF DESCRIPTION OF THE DRAWINGS

Non-limiting examples of the present disclosure will be described in the following, with reference to the appended drawings, in which:

FIG. 1 schematically represents an exploded view of an outdoor heatable seat assembly according to an example of the present disclosure;

FIG. 2 schematically represents an isometric view of a power source system according to an example of the present disclosure;

FIG. 3 schematically represents a cross-sectional view of a power source system coupled to a cover according to an example of the present disclosure;

FIG. 4 schematically represents an outdoor heatable seat assembly according to an example of the present disclosure;

FIG. 5A schematically represents an isometric view of an outdoor heatable seat assembly according to an example of the present disclosure;

FIG. 5B schematically represents an exploded view of the outdoor heatable seat assembly of FIG. 5B;

FIG. 6 schematically represents an exploded view of a power source system according to an example of the present disclosure;

FIG. 7 schematically represents a block diagram of a heatable seat assembly according to an example of the present disclosure;

FIG. 8 schematically represents a block diagram of a heatable seat assembly and a computing system according to an example of the present disclosure;

FIG. 9 is a block diagram of a computer-implemented method according to an example of the present disclosure: and

FIG. 10 schematically represents an exploded view of a heatable seat assembly to be used in a computer-implemented method according to an example of the present disclosure.

### DETAILED DESCRIPTION OF EXAMPLES

In these figures, the same reference signs have been used to designate matching elements.

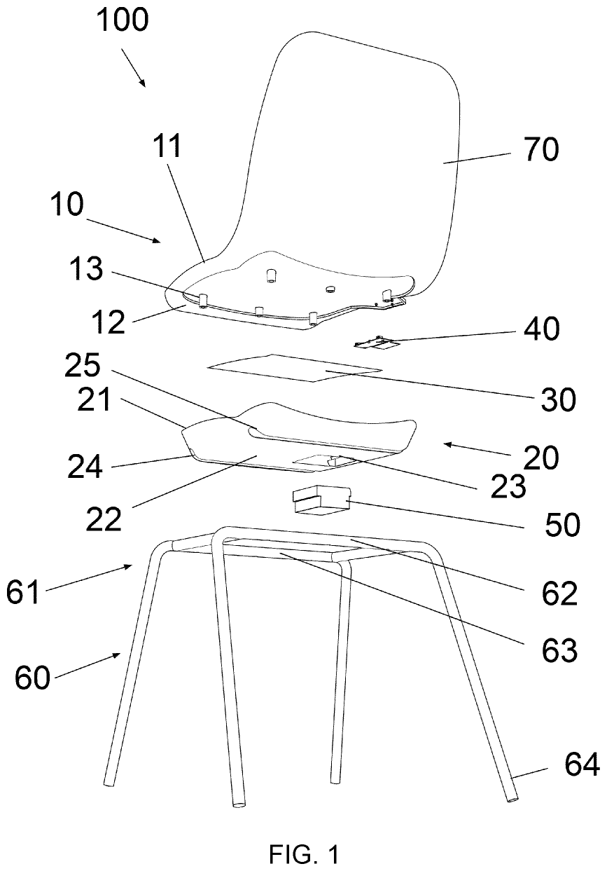

FIG. 1 schematically represents an exploded view of a heatable seat assembly 100 according to an example of the present disclosure. The seat assembly 100 comprises a seat 10 having a seat upper surface 11 configured to face a body of a seated user and a seat lower surface 12. Although not depicted in the exploded view of this figure, a cover 20 is attached to the seat 10. The cover comprises a cover upper surface 21 and a cover lower surface 22. The cover upper surface 21 faces the seat lower surface 12 and the cover lower surface 22 faces the floor. A heating system 30 to heat the seat 10 is arranged between the seat lower surface 12 and the cover upper surface 21.

The heatable seat assembly of this figure further comprises a seat controller 40 to control the temperature of the heating system and a detachable power source system 50 to supply energy to the heating system 30. The seat controller 40 of this example may be arranged between the cover and the seat. In some examples, the seat controller 40 is arranged inside the power source housing 51. The power source system 50 of this figure comprises a power source and a power source housing holding or enclosing the power source. In this figure, the power source system 50 may be inserted into a cavity 23 formed in the cover 20. The power source may be configured to supply a pulse modulated power, for example, a pulse width modulated power.

The heatable seat assembly 100 of this figure comprises a back portion 70 to support a back of a seated user. In this example, the seat 10 extends to the back portion 70. In other examples, the back portion and the seat may be independent elements. In further examples, the heatable seat assembly does not comprise a back portion. In still further examples, the back rest or back portion may extend from the cover.

In this example, the seat 10 and the cover 20 are manufactured from a plastic material, in particular, from an injection molded plastic material. This allows providing an acceptable mechanical resistance and a relatively cheap material and manufacturing process. In other examples, the seat is manufactured from metal, e.g. aluminum or stainless steel.

In FIG. 1, the heatable seat assembly comprises a support structure 60 that supports the seat 10 and rests on the floor. The support structure 60 of this figure comprises a connecting portion 61 that may be connected to the seat 10 and/or to the cover 20. The cover lower surface 22 may comprise a groove to engage the connecting portion 61. In this figure, the connection portion 61 comprises a pair of bars 62, 63 extending parallel to each other which may engages a pair of grooves 24, 25. Stability of the seat may thus be improved. In this figure, the pair of grooves 24, 25 extend from one lateral side to the other lateral side, i.e. perpendicular to the front—back direction of the seat.

In some examples, a fastener may connect the connecting portion 61 of the support structure to the seat 10 through the cover 20. In this example, a plurality of fastener receivers 13 protrudes from the seat lower surface 12. The fastener receivers 13 may also define the distance between the seat lower surface 12 and the cover upper surface 21. The fastener receivers 13 may comprise a threaded hole. The pair of bars 62, 63 and the cover may comprise a plurality of through holes that, once aligned, may allow fasteners to pass through them. Fasteners may be inserted through the plurality of through holes arranged at the pair of bars 62, 63 and screwed them onto the threaded holes of the fastener receivers 13. The cover 20 may thus be clamped between the seat 10 and the connecting portion 61 of the support structure 60.

In other examples, the cover is not clamped between the seat and the connecting portion. The cover may be attached to the seat by other attachment methods, e.g. through snap-fit elements or through additional fasteners.

In this example, the pair of bars 62, 63 extend from one lateral side to the other lateral side, i.e. from the left side to the right side of the left side. This pair of bars 62, 63 of this example are connected through one or more transversal bars. A base 64 consisting of four supporting legs extends from the pair of bars 62, 63. The supporting legs are outwardly inclined so as to improve the stackability of the heatable seat assembly.

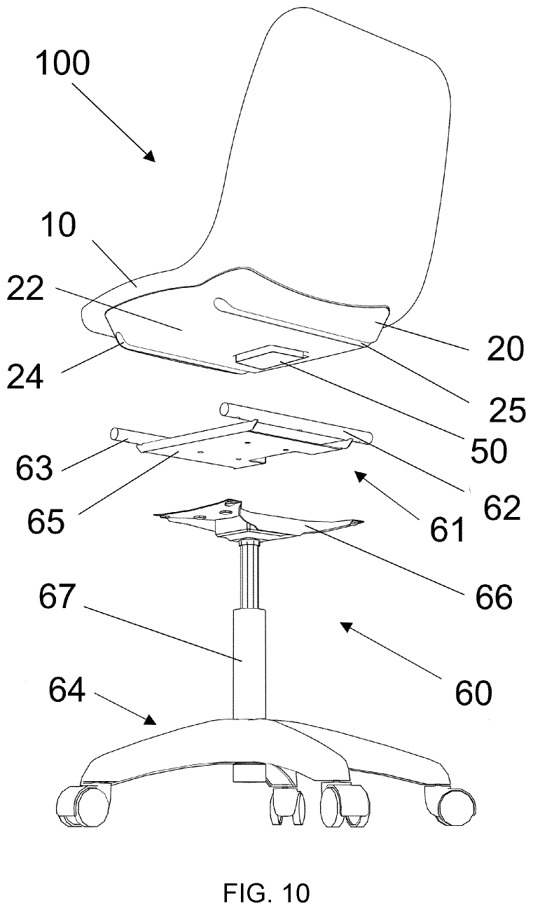

In other examples, the support structure comprises a plurality of wheels to move the outdoor heatable seat assembly. An example of this type of support structure may be the support structure of FIG. 10.

In some examples, the heating system may be a flexible heating mat. The flexible heating mat may comprise a polyamide support structure and an electrical conductor, e.g. copper.

The electrical conductor may be heated and this heat may be transferred to the seat lower surface through the air between the flexible heating mat and the seat lower surface. Heat of the seat lower surface may then be transferred to the seat upper surface through the material of the seat. Other types of heating systems may also be suitable, e.g. induction heating systems.

In some examples, the heatable seat assembly may comprise a temperature sensor to obtain the temperature of the seat upper surface. In some examples, this temperature sensor may be arranged on the seat upper surface. However, in other examples, the temperature sensor may be arranged on the seat lower surface, e.g. glued to the seat lower surface. The temperature sensor arranged on the seat lower surface measures the temperature of the seat lower surface. In some examples, the value obtained for the seat lower surface may be assumed that corresponds to the temperature of the seat upper surface. In other examples, the temperature of the seat upper surface may be an estimation calculated from the temperature of the seat lower surface taking into account the thermal conductivity of the material of the seat.

In some examples, the heatable seat assembly comprises a temperature selector. The user may select the desired temperature of the seat through this temperature selector. This temperature selector may be arranged at one lateral side of the seat. The user may thus easily select the desired temperature setpoint.

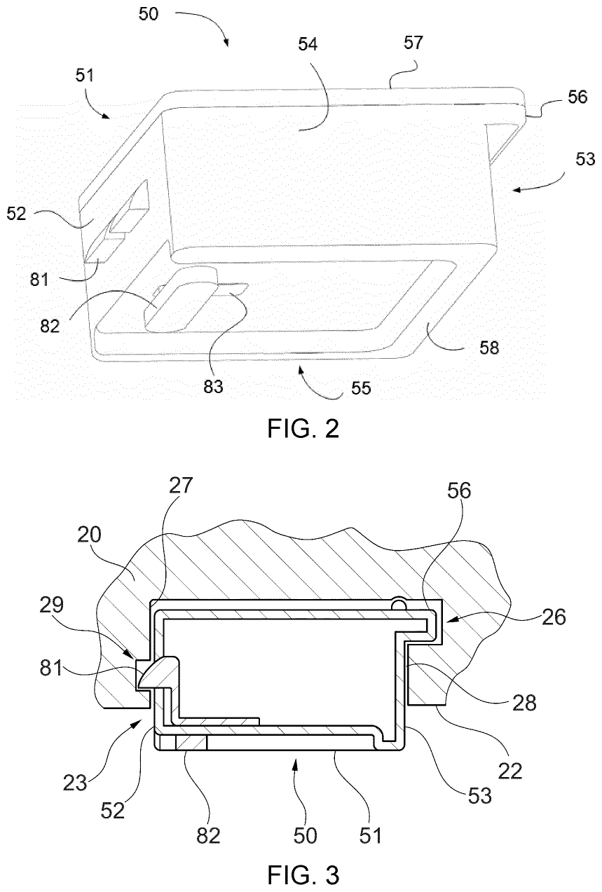

FIG. 2 schematically represents an isometric view of a power source system 50 according to an example of the present disclosure. The power source housing 51 of the power source system 50 of this figure comprises a first side 52 having a tab element 81 and a second side 53 comprising a protrusion 56 extending from the second side 53. The first side 52 is opposite to the second side 53. A third side 54 and a fourth side 55 connects the first side 52 to the second side 53. These sides may define a substantially rectangular cross-section.

The power source housing 51 of this example comprise an upper surface 57 to face the cover lower surface and a lower surface 58. The protrusion 56 is arranged adjacent to the upper surface 57 so that upper surface 57 is greater than the lower surface 58. In some examples, electrical connectors may be arranged on the upper surface 57 so as to power the heating system.

In this example, when the power source housing 51 is arranged at the cavity of the cover lower surface, the second side 53 faces towards the seat assembly and the first side faces an outside of the seat assembly. The third side 54 faces a back portion of the seat and the fourth side 55 faces a front portion of the seat.

In this example, the power source housing 51 comprises a lever 82 to control the movement of the tab element 81 relative to the portion of the wall of the cavity of the cover lower surface. The lever 82 may be displaced along a slot 83 which extends in a direction parallel to the third side 54 and to the fourth side 55. Moving the lever 82 may cause the movement of the tab element 81. In this example, moving the lever 82 towards the second side 53 causes the retraction of the tab element 81 and moving the lever 82 towards the first side 52 causes an outward movement of the tab element 81.

In some examples, the power source housing 51 comprises a main body defining an inner space to accommodate the power source and a lid to close the main body. The lid may be detached or moved to change the power source. In some examples, the power source in the power source housing may be recharged in an external recharger unit. In other examples, the power source may be removed from the power source housing for connecting the power source to the external source housing.

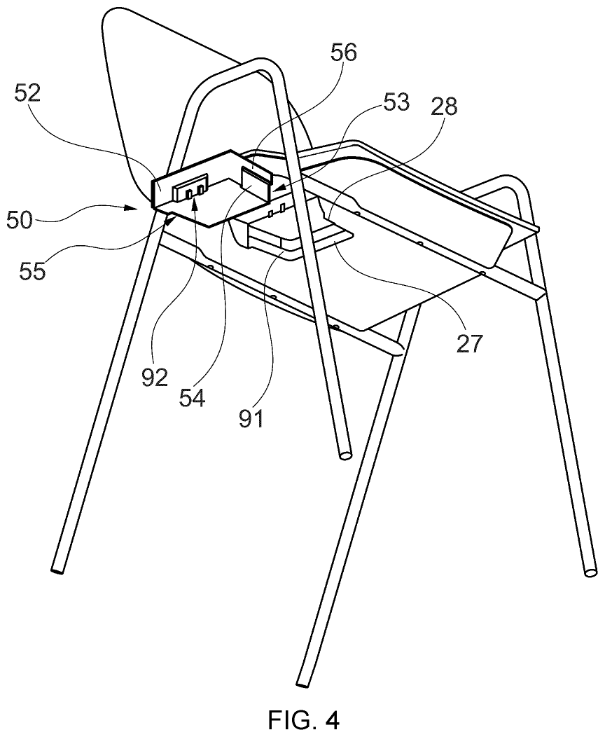

FIG. 3 schematically represents a cross-sectional view along a direction extending from one lateral side of the seat to the other lateral side of the seat of a power source system 50 coupled to a cover 20 according to an example of the present disclosure. The power source system 50 may be according to any of the examples herein disclosed. The power source system 50 comprises a power source housing 51 enclosing a power source (not shown in FIG. 4). In some examples, the seat controller may be arranged inside the power source housing 51.

The power source housing 51 of this figure extends from a first side 52 to a second side 53 in a direction extending from one lateral side to the other lateral side. The second side 53 is opposite to the first side 52. In this example, the first side 52 comprises a movable tab element 81 and a protrusion 56 outwardly extends from the second side 53.

The power source housing 51 of this figure is inserted into a cavity 23 formed at the cover lower side 22 of the cover 20. The shape of the cavity 23 substantially corresponds to the shape of the power source housing 51. The cavity 23 comprises a first wall 27 and a second wall 28, opposite to the first wall 27. The cavity 23 of this example comprises a recess 26 adjacent to the second wall 28 and an indentation 29 formed at the first wall 27. The first wall 27 is more exterior than the second wall 28. The first wall 27 is arranged close or adjacent to a lateral side of the cover lower surface. A pair of parallel walls may connect the first wall 27 to the second 28. In this example, the cavity is formed by four walls defining a substantially rectangular cross-section. However, in other examples, the cavity may be defined by three walls and an open side.

In this figure, the protrusion 56 of the power source housing 51 fits the recess 26 of the cavity 23. The recess 26 may hold the protrusion 56 of the power source housing 51. For example, a lower wall of the recess 26 may be in contact with a lower wall of the protrusion 56. The tab element 81 of the power source housing 51 of this figure engages an indentation 29 formed at the first wall 27 of the cavity 23. Accordingly, the power source housing 51 of this figure is coupled to the cavity 23 of the cover 20 by the combination of the action of the tab element 81 fitting the indentation 29 of the first wall 27 and the engagement of the protrusion 56 with the recess 26. In further examples, the tab element may exercise a pressure against the first wall.

During the insertion of the power source system 50 into the cavity 23, the power source system is moved towards the cavity with an inclined orientation and the distal end of the protrusion 56 is positioned into the recess 26. Then, the protrusion 56 (and the whole power source system 50) pivots about the recess 26 so that the power source housing 51 substantially fits the cavity 23. The power source housing is thus configured to tilt about the recess 26 of the cavity 23. Next, the tab element 81 is moved towards the indentation 29 so as to engage the indentation. The power source housing 51 is then removable coupled to the cover of the heatable seat assembly.

The seat assembly may comprise a locking mechanism to lock the power source housing onto the cover. In some examples, the cover may comprise a locking pin configured to engage and disengage a locking hole arranged on the power source housing for locking the power source onto the seat. For example, the upper surface of the power source housing may comprise a locking hole to receive the locking pin. The power source housing may thus be securely attached to the seat. In other examples, the power source housing may comprise the locking pin and the cover, e.g. the wall defining the cavity, may comprise the locking hole.

The power source may power the driving mechanism or system of the locking pin for locking and unlocking the power source housing. For example, the power source may selectively power the driving mechanism, e.g. an electromagnet, to move the locking pin. The driving mechanism may be remotely activated, e.g. through a NFC protocol. Security and integrity of the seat assembly may thus be enhanced.

FIG. 4 schematically represents a heatable seat assembly according to an example of the present disclosure. In this example, the power source housing 51 may slide within a portion of the cavity 23. The power source housing 51 may be inserted into the cavity by a movement substantially parallel to the seat. The power source housing is thus configured to slide within the cavity. The power source housing 51 may thus be easily inserted into the cavity.

The power source housing 51 of this figure extends from a first side 52 to a second side 53. A third side 54 and a fourth side 55 connects the first side 52 to the second side 53. The first side 52 and the second side 53 are substantially parallel to the lateral sides of the seat and the third side 54 and the fourth side 55 are substantially parallel to front and back sides of the seat.

The third side 54 and the fourth side 55 of the power source housing 51 of this example respectively comprise an upper wall, a lower wall and a connecting wall connecting the upper wall to the lower wall. The upper wall is substantially parallel to the lower wall. The connecting wall is substantially parallel to the seat, i.e. perpendicular to the upper wall. In this example, the connecting wall outwardly extends from the lower wall to the upper wall. The connecting wall and the upper wall of the third side 54 and the fourth side 55 of the power source housing 51 are respectively a protrusion.

The power source housing may slide into the cavity 23 by moving the second side 53 towards the first wall 27 of the cavity 23. The cavity 23 of this example is defined by the first wall 27 connecting a second wall 28 to a third wall 95. The cavity 23 comprises an aperture to receive the power source housing, arranged at the opposite side of the first wall 27.

In this example, the second wall 28 and the third wall 95 respectively comprises an upper portion and lower portion connected through a connecting portion. The respective upper portion and the connecting portion of the second wall 28 and the third wall 95 respectively defines a recess. The protrusions arranged at the third side 54 and at the fourth side 55 of the power source housing 51 fits into the recesses arranged at the second wall 28 at the third wall 95 of the cavity 23. The power source housing 51 may thus be held inside the cavity 23.

A locking mechanism may be provided to lock the power source housing into the cavity. In some examples, the cover may comprise a locking pin that may engage in a locking hole arranged on the power source housing. In other examples, the locking pin may be arranged on the power source housing and the locking hole at the cover. The driving mechanism of the locking pin may be powered by the power source of the power source system.

The power source system 50 of this example comprises an electrical connector 92 configured to be connected to an electrical connector of another power source system. This second power system may be used to charge the power source system 50 coupled to the cavity so as to allow the driving mechanism of the locking pin to unlock the locking pin and release the coupled power source system.

In some examples, the seat controller may be arranged within the power source housing 51. The seat controller and the power source system may thus be detached from the cover together. Connections between the seat controller and the power source may thus be easily performed.

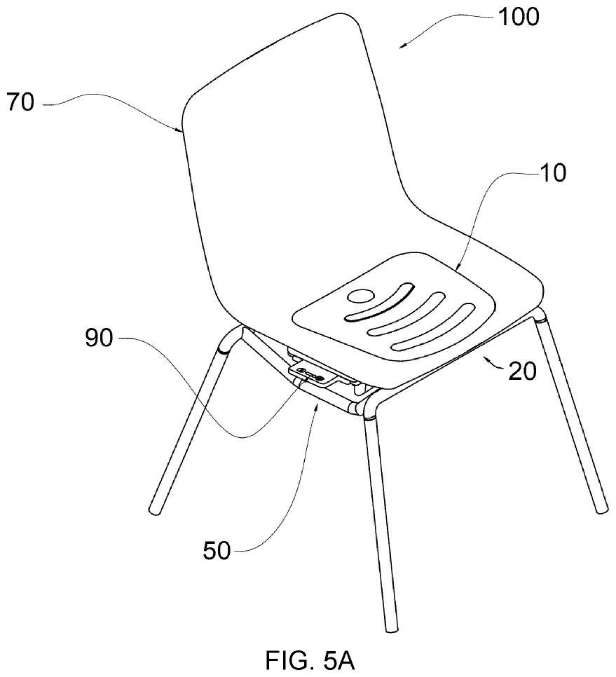

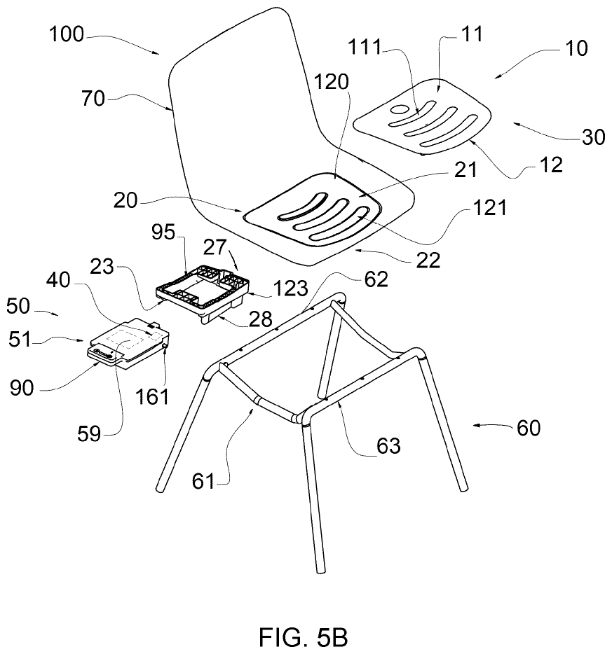

FIG. 5A schematically represents an isometric view of an outdoor heatable seat assembly according to an example of the present disclosure and FIG. 5B schematically represents an exploded view of the outdoor heatable seat assembly 100 of FIG. 5B. The seat assembly 100 comprises a seat 10 having a seat upper surface 11 configured to face a body of a seated user when the user is seated on the outdoor heatable seat assembly and a seat lower surface 12.

Although not depicted in the exploded view of FIG. 5B, a cover 20 is attached to the seat 10. The cover comprises a cover upper surface 21 and a cover lower surface 22. The cover upper surface 21 faces the seat lower surface 12 and the cover lower surface 22 faces the floor when the user is seated on the outdoor heatable seat assembly. The cover upper surface 21 comprises a depression 120 to receive a heating system 30. Although not illustrated in the exploded view of FIG. 5B, the heating system 30 is arranged between the seat lower surface 12 and the cover upper surface 21. The heating system of these figures may be according to any of the examples herein disclosed.

In this example, the heating system 30 is connected to the seat lower surface 12, e.g. through glue or adhesive. The heating system of this figure substantially fits the seat lower surface 12. In other examples, the heating system may be connected to the cover upper surface 21. In further examples, the heating system may be laid on the cover upper surface, e.g. on the depression 120. The heating system may comprise an electrical conductor embedded in a polyamide support structure. The electrical conductor may be heated and this heat may be transferred to the seat lower surface 12. This heat may then be transferred through the material of the seat, e.g. metal, to the seat upper surface 11.

Fasteners may be used to connect the seat 10 to the cover 20. The seat 12 of this figure fits the depression 120 of the cover upper surface 21. In this figure, the depression 120 of the cover upper surface 21 comprises a plurality of protrusions 121. These protrusions fit a plurality of slots 111 of the seat 10.

The seat 10 of this figure is an upper closure of the heating system 30 and the cover 20 is a lower closure of the heating system 30. In this figure, the cover 20 extends to a back rest or back portion 70. The back portion 70 of this figure is integrated with the cover. The cover 20 and the back portion 70 of this figure are manufactured from plastic, e.g. from polypropylene. In this figure, the seat 10 is made from metal, e.g. aluminum or stainless steel. The heatable seat assembly may thus be used in an outdoor environment.

For clarity purposes, in FIG. 5B a cover body 123 defining the cavity 23 has been illustrated separated from the cover lower surface 22. However, the cover body 123 is attached or integrally formed with cover lower surface 22. The cover body 123 thus defines the cavity 23 of the cover lower surface 22.

The outdoor heatably seat assembly comprises a detachable power source system 50 to supply energy to the heating system 30. The power source system 50 comprises a power source and a power source housing 51. The cavity 23 of this figure is configured to receive the power source housing 51.

The cavity 23 of this example comprises a first wall 27 connecting a second wall 28 to a third wall 95. The cavity 23 comprises an aperture to receive the power source housing 51, arranged at the opposite side of the first wall 27. The first wall 27 and the second wall 28 may comprise a groove or a recess to receive protrusion of the power source housing 51.

In this example, the heatable seat assembly of this example comprises a seat controller 40 arranged inside the power source housing 51. The power source 59 and the seat controller 40 are thus contained in the power source housing 51. The power source system 50 and the seat controller 40 may thus be inserted into the cavity 23 of the cover lower surface 22.

The power source housing 51 of this example is configured to slide within a portion of the cavity 23 of the cover lower surface 22. The cavity 23 has an aperture to insert the power source housing. The cavity may comprise a pair of opposite recesses. The power source housing 51 may comprise a pair of opposite protrusions that substantially fit the opposite recesses of the cavity. The power source housing 51 may thus be held through the protrusions fitting the opposite recesses.

In this example, the heatable seat assembly comprises a temperature selector 90. The temperature selector 90 of these figures is arranged at the power source housing 51. This temperature selector 90 may be used by the user to select the desired temperature. In some examples, a temperature sensor may be arranged on the seat 10 to indicate the temperature of the seat upper surface. The temperature provided by the sensor and the temperature selected by the user may be employed to provide a power pattern. The seat controller may thus regulate the power supplied by the power source to the heating system.

In this example, the power source housing 51 comprises a locking pin 161. The locking pin 161 may be inserted in a locking hole arranged on a wall of the cover body. The locking 161 may thus secure the power source housing 51

In these figures, the heatable seat assembly 100 comprises a support structure 60 that supports the seat 10 and rests on the floor. The support structure 60 of this figure comprises a connecting portion 61 that may be connected to the seat 10 and/or to the cover 20 according to any of the examples herein disclosed. In this figure, the connection portion 61 comprises a pair of bars 62, 63 extending parallel to each other which may engages a pair of grooves formed on the cover 20. The connection portion 61 may be connected according to any of the examples herein disclosed.

In this example, the pair of bars 62, 63 extend from one lateral side to the other lateral side, i.e. from the left side to the right side of the left side. This pair of bars 62, 63 of this example are connected through one or more transversal bars. A base 64 consisting of four supporting legs extends from the pair of bars 62, 63.

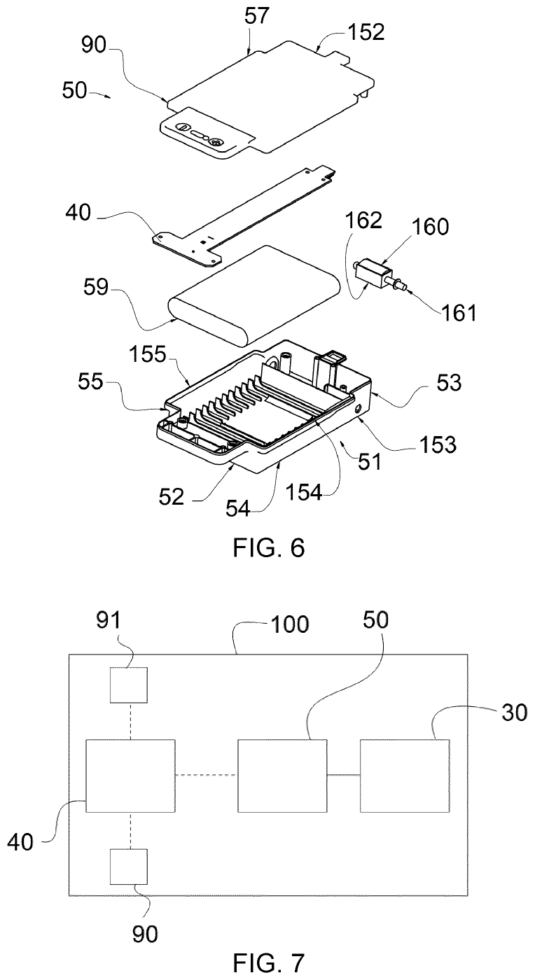

FIG. 6 schematically represents an exploded view of a power source system 50 according to an example of the present disclosure. The power source housing 51 of this figure comprises a first side 52 and a second side 53 opposite to the first side 52. A third side 54 and a fourth side connect the first side 52 to the second side 53. These sides form a main body 153 to house at least the power source 59. The main body 153 defines an inner space to accommodate at least the power source 59.

When the power source system 50 is inserted into the cavity 23 of the cover, the first side 52 faces an outside of the seat assembly and the second side 53 faces towards the seat assembly. The third side 54 faces a back portion of the seat assembly and the fourth side 55 faces a front portion of the seat assembly. Accordingly, when the power source system is mounted on the cavity of the cover lower surface, the user may interact with a temperature selector 90 that is arranged on the first side 52. The temperature selector 90 may comprise tactile buttons and/or a tactile screen to select the desired temperature.

The power source housing 51 of this figure comprises an upper surface 57 to face the cover. The upper surface 57 is defined by a lid 152 that is connected to the main body 153. In some examples, the lid 152 is removably connected to the main body 153, e.g. through fasteners. The lid 152 of this example closes the main body 153 to form the power source housing 51.

In this example, the third side 54 comprises a lateral protrusion 154 and the fourth side 55 comprises a lateral protrusion 155. These lateral protrusions 154 and 155 may fit a corresponding groove or recess defined on the second wall 28 and the third wall 95 of the cavity 23, as depicted in FIG. 5B. The power source housing may thus be supported by these recesses arranged on the cavity 23. The power source housing 51 may thus slide into the cavity 23.

The power source 59 of this example is arranged inside the power source housing 51. The power source 59 may be a rechargeable battery. For example, the rechargeable battery may be made from nickel metal hydride (NiMH). NiMH rechargeable batteries hold a charge longer, can be recharged more times over their life spans, and have higher capacities than those made with nickel-cadmium.

In this example, the seat controller 40 is arranged within the power source housing 51. Connections between the seat controller 40 and the power source 59 may thus be simplified. Furthermore, the controller may be removed together with power source system 50 from the seat assembly 100. Accordingly, some of the most expensive components of the heatable seat assembly 100 may be removed when the heatable seat assembly is not in use. The seat controller 40 of this example may be operable according to any of the disclosed herein.

In the example of this figure, a locking mechanism 160 is arranged inside the power source housing 51. The locking mechanism 160 comprises a locking pin 161 configured to engage and disengage a locking hole arranged on the walls that define the cavity 23 of the cover. The locking mechanism 160 of this figure further comprises a driving system 162 to selectively move the locking pin 161 from a locking position to an unlocking position. In this example, the driving system comprises an electromagnet. The electromagnet may be selectively powered to apply a magnetic force against the inner end of the locking pin. This magnetic force may cause the movement of the locking pin 161 from a locking position to an unlocking position. In this example, the seat controller 40 may instruct the power source 59 to power the electromagnet. Additionally, or alternatively, an external power source may be coupled to the driving system 162 to move the locking pin 161. Although not depicted in this figure, the power source system may comprise an electrical connector configured to be connected to an electrical connector of an external power source.

The seat controller 40 may receive an instruction from a user to unlock the locking pin. For example, the seat controller 40 may receive the instruction through a wireless connection, e.g. using a NFC protocol. A tablet and/or a smartphone may be used to send this instruction to the seat controller 40. The locking mechanism thus acts as an anti-theft system.

FIG. 7 schematically represents a block diagram of a heatable seat assembly 100 according to an example of the present disclosure. The heatable seat assembly 100 comprises a seat controller 40 to regulate the power supplied by the power source system 50 to the heating system 30.

The seat controller 40 of this figure is configured to obtain an indication of the temperature of the seat upper surface. In this example, the indication of the temperature of the seat upper surface is received by the seat controller 40 from a temperature sensor 91 arranged on the seat. As explained before, the temperature sensor 91 may be arranged at the seat upper surface or at the seat lower surface.

The seat controller 40 is configured to receive a temperature setpoint. In this example, the seat controller is configured to receive the temperature setpoint from a temperature selector 90 arranged on the heatable seat assembly. A seated user may thus select the temperature setpoint by interacting with the temperature selector 90. In other examples, the temperature setpoint may be received from a computing system external from the heatable seat assembly.

In addition, the seat controller 40 may be configured to determine, based on the temperature setpoint and on the indication of the temperature of the seat upper surface, a power pattern to be supplied by the power source system 50 to the heating system 30. In some examples, the seat controller 40 may control the operation of a switch to regulate the power supplied by the power source. The power source may thus be able to provide a PWM electrical signal and/or an ON/OFF electrical signal to the heating system. In further examples, a digital control loop mechanism, e.g. PID, may be used to regulate the power pattern supplied by the power source.

The seat controller 40 may also be configured to set, based on the temperature setpoint, an upper temperature setpoint limit and a lower temperature setpoint limit, and adjust the power pattern to maintain the temperature of the seat upper surface between the upper temperature setpoint limit and the lower temperature setpoint limit. In some examples, adjusting the power pattern comprises adjusting a width of a pulse width modulated power. In further examples, instead of adjusting the width of the pulse width modulated power, the ON/OFF time may be adjusted to maintain the temperature of the seat upper surface within the upper and lower temperature setpoint limits.

The upper and the lower temperature setpoint limit may be predefined for each temperature setpoint. In other examples, these temperature setpoint limits may be calculated for each temperature setpoint. In some examples, the upper temperature setpoint limit may be a first temperature value added to the temperature setpoint and the lower temperature setpoint limit may be the temperature setpoint minus a second temperature value. Depending on the temperature setpoint, the first temperature value may be equal or different to the second temperature value. For example, for a temperature setpoint of 30° C., the upper temperature setpoint limit may be 31° C. and the lower temperature setpoint limit may be 29.5° C.

The temperature of the seat is thus constrained between the upper temperature setpoint limit and the lower temperature setpoint limit. The temperature of the seat may thus be allowed to vary within certain limits that do not affect the comfort of the seated user, while reducing the power consumption of the heating system. Temperature of the seat may thus be controlled in real-time by adjusting the amount of power delivered to the heating system. For example, if the seat controller detects that the temperature of the seat upper surface is close to the upper temperature setpoint limit, the seat controller would reduce the width of the pulse width modulated power (and/or the ON time of power source) to be delivered to the heating system to reduce the amount of energy; whereas, if the temperature of the seat upper surface is close to the lower temperature setpoint limit, the seat controller would increase the width of the pulse width modulated power (and/or the ON time of the power source) to be delivered to the heating system to increase the amount of energy and, therefore, the temperature of the seat upper surface.

In some examples, the seat controller may be configured to determine a seat occupancy. In an example, the seat controller may receive a signal from an occupancy sensor, e.g. a pressure sensor arranged on the seat. In other examples, the seat occupancy sensor may be determined by obtaining a temperature variation of the temperature of the seat upper surface during a predetermined period of time and by comparing the obtained temperature variation with a predetermined temperature variation. A body of a seated user may act as a temperature barrier reducing the effect of the outdoor temperature. Accordingly, if the user gets up, the temperature of the seat upper surface would be more influenced by the outdoor temperature, i.e. the temperature of the seat upper surface would drop. A temperature variation greater than the predetermined temperature variation may be indicative that a user has sat down or got up.

Furthermore, the seat controller may be configured to determine a seat occupancy time. For example, the seat occupancy time may be determined by counting the time at which the temperature variation of the temperature of the seat upper surface is lower than a predetermined variation. For example, this may be indicative that a user is seated. This occupancy time may be sent to the computing system.

In some examples, the seat controller may be configured to determine a heating time of the heating system. The heating time may be used to determine the charging status of the power source. In some examples, the heating time may be obtained may counting the time at which the power source is powering the heating system. For example, the heating time may be obtained by adding the widths of pulse-modulated width power supplied by to the heating system and/or by adding the ON periods of the power source.

In some examples, the seat controller may receive a signal from the power source signal about the power source charge status. In some examples, the seat controller may estimate the power source charge status from the heating time. An indication of the power source charge status may then be sent to a computing system. Recharging the power source may thus be efficiently scheduled.

In some examples, the seat controller may receive an instruction to unlock the power source housing. The seat controller may then instruct the power source to power a driving mechanism to move a locking pin for unlocking the power source housing. The instruction for unlocking the power source housing may be received from a user interface device and/or from a central controller. A NFC protocol may be used for this data transmission.

The seat controller may include a processor and a non-transitory machine-readable storage medium coupled to the processor. The processor performs operations on data, for example, operations for controlling the temperature of the seat.

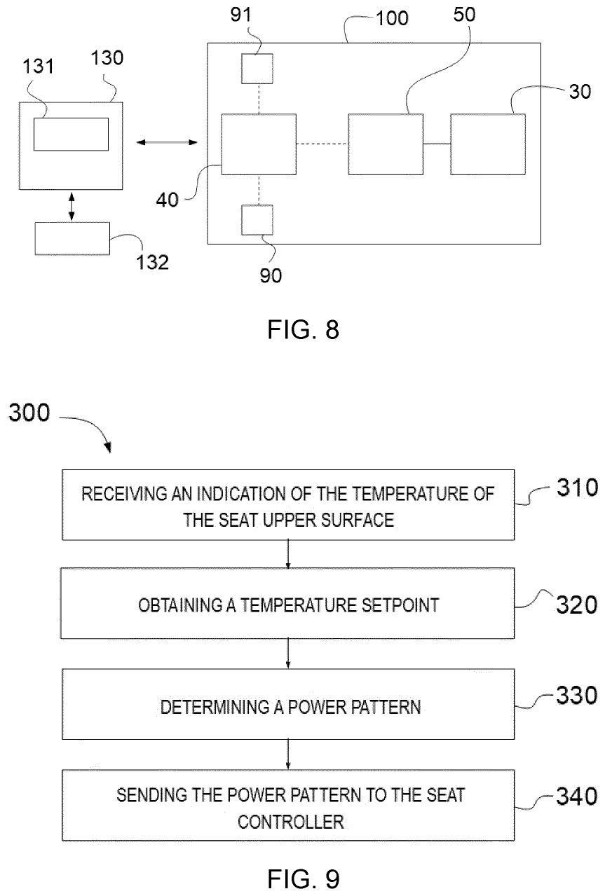

FIG. 8 schematically represents a block diagram of a heatable seat assembly 100 and a computing system 130 according to an example of the present disclosure. The seat controller 40 is wirelessly connected to the computing system 130. The seat controller 40 transmits and receives data from the computing system 130. In some examples, the computing system may be arranged in an indoor location and the seat controller in an outdoor location. The wireless technology may thus be an indoor/outdoor wireless technology. For example, NFC, LoraWan (Low-power wide-area network) or Bluetooth technologies may be used for transmitting data between the seat controller 40 and the computing system 130.

The computing system 130 includes a processor 131 that performs operations on data, for example, for controlling the operation of one or more heatable seat assemblies. The processor 131 may execute a computing program 132 comprising instructions that cause the processor 131 to control the operation of one or more heatable seat assemblies. The computing system may be a computer, a smartphone, a tablet, or a server.

In some examples, the processor 131 may be a dedicated processor for controlling the operation of one or more heatable seat assemblies. In other examples, the processor may also control other tasks of a restaurant, such as orders and table reservations.

The computer program 132 may be embodied on a storage medium (for example, a CD-ROM, a DVD, a USB drive, a computer memory or a read-only memory) or carried on a carrier signal (for example, on an electrical or optical carrier signal).

The computer program may be in the form of source code, object code, a code intermediate source and object code such as in partially compiled form, or in any other form suitable for use in implementing the methods of controlling an auxiliary illumination system according to the present disclosure. The carrier may be any entity or device capable of carrying the computer program.

For example, the carrier may comprise a storage medium, such as a ROM, for example a CD ROM or a semiconductor ROM, or a magnetic recording medium, for example a hard disk. Further, the carrier may be a transmissible carrier such as an electrical or optical signal, which may be conveyed via electrical or optical cable or by radio or other means.

The seat controller 40 of this example is configured to receive, from the computing system 130, the power pattern to be supplied by the power source system 50 to the heating system 30. In this example, the power pattern is determined by the computing system 130. The computing system 130 receives an indication of the temperature of the seat upper surface from the seat controller 40 and a temperature setpoint to determine the power pattern. In this figure, the seat controller 40 may receive the temperature setpoint from a temperature selector arranged on the heatable seat assembly. However, in other examples, the temperature setpoint may be received by the computing system from a user interface device, e.g. keyboard and/or a touchable screen.

In some examples, the seat controller 40 may send an indication of the seat occupancy, of the occupancy time and/or of the heating time and/or of the power source charge status to the computing system 130. For example, the computing system 130 may receive the seat occupancy from a plurality of seat controllers for determining the total occupancy of a specific zone. Similarly, the computing system 130 may receive the occupancy time and/or the heating time and/or the power source charge status from a plurality of seat controllers of different heatable seat assemblies.

The processor 131 of the computing system 130 may be configured to perform any computer-implemented method for controlling the heat of a heatable seat assembly according to any of the examples herein disclosed.

FIG. 9 is a block diagram of a computer-implemented method 300 according to an example of the present disclosure. The computer-implemented method 300 may be performed by a processor comprised in a computing system according to any of the examples herein disclosed. A computing program may comprise instructions, which, when the program is executed by the process, cause the processor to carry out the computer-implemented method according to any of the examples herein disclosed.

The computer-implemented method 300 may be used for controlling a temperature of a plurality of heatable seat assemblies. In some examples, the heatable seat assemblies may according to any of the examples herein disclosed. For example, the computer-implemented method 300 may be used for controlling a temperature of a plurality of outdoor heatable seat assemblies. The method 300 may also be used to control a plurality of heatable seat assemblies, e.g. a plurality of heatable seat assemblies according to the heatable seat assembly of FIG. 10.

At block 310, receiving, from a seat controller of a plurality of heatable seat assemblies, an indication of the temperature of a seat upper surface of a seat of each of the plurality of heatable seat assemblies is represented. A computing system may thus receive an indication of the temperature of the seat upper surface of the plurality of heatable seat assemblies. The computing system may thus be wirelessly connected with a plurality of seat controllers. The indication of the temperature of the seat upper surface may be different from one another of the heatable seat assemblies.

The seat controller of each of the heatable seat assemblies may receive an indication of the temperature of the corresponding seat upper surface from a temperature sensor according to any of the examples herein disclosed. The seat controller of each of the heatable seat assemblies may then transmit the indication of the temperature of the seat upper surface.

Obtaining a temperature setpoint for each of the plurality of heatable seat assemblies is represented at block 320. The computing system may thus receive a different temperature setpoint for each of the heatable seat assemblies.

In some examples, obtaining the temperature setpoint for each of the plurality of heatable seat assemblies comprises receiving the temperature setpoint from a temperature selector of the corresponding heatable seat assembly of the plurality of heatable seat assemblies. The temperature setpoint of each heatable seat assembly may thus be received from a temperature selector arranged in each of the heatable seat assemblies. In these examples, seated users may send different temperature setpoints according to their thermal comfort.

In some of these examples, the temperature selector may send the temperature setpoint to the seat controller and then the seat controller may transmit this temperature setpoint to the computing system. In other examples, the temperature selector of the heatable seat assembly may be in wirelessly communication with the computing system, so that the temperature selector may directly transmit the setpoint to the computing system.

In some examples, obtaining the temperature setpoint for each of the plurality of heatable seat assemblies comprises receiving the corresponding temperature setpoint from a user interface device remote from the plurality of the heatable seat assemblies. A keyboard and/or a touchable screen may be used for setting a temperature setpoint. The selection of the temperature setpoint may thus be centralized. In some examples, the temperature setpoint may be the same for each of the heatable seat assemblies, however, in other examples, different temperature setpoints may be set for different heatable seat assemblies.

At block 330, determining, for each of the plurality of heatable seat assemblies, a power pattern to be supplied by a power source to a heating system of each of the plurality of heatable seat assemblies is represented. The determination of the power pattern to be supplied by the power source of each of the plurality of heatable seat assemblies is based on the corresponding temperature setpoint and on the indication of the temperature of the seat upper surface. The computing system may thus determine a different power pattern for different heatable seat assemblies.

Sending the corresponding power pattern to the seat controller of each of the plurality of the heatable seat assemblies is represented at block 340. The computing system may thus wirelessly transmit to the seat controller the power pattern determined for the specific conditions of the heatable seat assembly.

Wireless communications, e.g. NFC, LoraWan or Bluetooth technologies, may be used for receiving and transmitting data by the computing system. A computing system located remote from the plurality of heatable seat assemblies may be used to determine the power pattern to be supplied for each power source to the corresponding heating system. For example, the computing system may be located in an indoor zone of a restaurant and the seat controller in an outdoor zone. A wireless communication between an indoor zone of a restaurant and an outdoor zone, e.g. a terrace, may thus be established. The computing system may be a dedicated computing system or a computing system used for further purposes, e.g. management of the restaurant, stock control, etc. Personnel of a restaurant may thus control the operation of the plurality of heatable seat assemblies. This may allow to simplify the seat controller and to reduce the cost of the heatable seat assembly. In addition, the control of the temperature of the heatable seat assemblies may be a module of a program for managing a restaurant.

In some examples, the computer-implemented method 300 may further comprise activating one or more of the heatable seat assemblies of the plurality of heatable seat assemblies. The seat controller may thus be instructed to turn on the heating system. This may allow pre-heating the seat before a user sits on the heatable seat assembly. This may also allow activating the heatable seat assemblies occupied by users. Energy efficiency may thus be improved.

The computer-implemented method may comprise obtaining an indication to activate a heatable seat assembly of the plurality of heatable seat assemblies.

In some examples, this indication may be received from personnel of the zone having the heatable seat assemblies. For example, the computing system of a restaurant may receive from restaurant personnel, an indication of which heatable seat assemblies are to be used. The computing system may then activate the selected heatable seat assemblies.

The computer-implemented method may further comprise setting, based on the temperature setpoint, an upper temperature setpoint limit and a lower temperature setpoint limit for each of the plurality of heatable seat assemblies; determining, for each of the plurality of heatable seat assemblies, a power pattern to maintain the temperature of the seat upper surface between the upper temperature setpoint limit and the lower temperature setpoint limit; and then, sending the power pattern to the corresponding seat controller of the plurality of heatable seat assemblies.

In some examples, determining the power pattern may include calculating a width of a pulse width modulated power to maintain the temperature of the seat upper surface between the upper temperature setpoint limit and the lower temperature setpoint limit. In further examples, determining the power pattern may comprise calculating an ON/OFF time for each of the heating system may be calculated.

A storage medium may comprise a predetermined upper temperature setpoint and a predetermined lower temperature setpoint limit for a specific temperature setpoint. The computing system may then assign the temperature setpoint limits to each of the temperature setpoints. The power pattern, e.g. the width of a PWM signal or an ON/OFF time of the electrical signal, may be adjusted to maintain the temperature of the seat upper surface within these temperature setpoint limits. Temperature differences within the lower temperature setpoint limit and the upper temperature setpoint limit is inappreciable by a seated user.

In some examples, the computer-implemented method may further comprise determining a seat occupancy for each of the plurality of heatable seat assemblies. The computing system may then determine the overall seat occupancy of the plurality of heatable seat assemblies, e.g. the occupancy of a restaurant, in real time. Management and control of the restaurant may thus be improved.

In some examples, the heatable seat assemblies may comprise a seat occupancy sensor to indicate the seat occupancy. The computing system may receive the seat occupancy, directly or through the seat controller, from the seat occupancy sensor. In other examples, each seat controller may determine the corresponding seat occupancy and transmit this data to the computing system.

In other examples, the computing system may indirectly determine the seat occupancy. For example, the determination of the seat occupancy for each of the plurality of heatable seat assemblies may comprise obtaining, for each of the plurality of heatable seat assemblies, a temperature variation of the temperature of the seat upper surface during a predetermined period of time, and comparing, for each of the plurality of heatable seat assemblies, the obtained temperature variation with a predetermined temperature variation. A temperature variation greater than a predetermined temperature variation may indicate that a user has sat down or got up from the heatable seat assembly. The computing system may further send an alert to the waiter(s) if a new user has just sat down.

In some examples, the computer-implemented method may further comprise determining, for each of the plurality of heatable seat assemblies, a seat occupancy time. The computing system may count the time at which each of the heatable seat assemblies is occupied.

In some examples, the computing system may receive a seat occupancy time determined by the seat controller of each of the heatable seat assemblies.

Determining the seat occupancy time for each heatable seat assembly may improve the Accuracy of the control of the occupancy of a restaurant. In addition, this data may be used for statistical purposes. For example, online booking systems may in real know the occupancy of a restaurant. This may increase the number of reservations. Furthermore, this data to increase the efficiency of the service of the restaurant. For example, waiter(s) may easily detect which users have been sitting the longest or which users have just sat down.

In some examples, the computer-implemented method may further comprise obtaining, for each of the plurality of heatable seat assemblies, a heating time of the heating system and/or a power source charge status. The computing system may determine the time at which the power source is supplying energy to the heating system. For example, the heating time of a heating system may be determined by analyzing the power pattern supplied by the power source to this heating system during a period of time. Power source charge status of the power sources may thus be determined. In addition, this data may be used for statistical purposes or even for charging for the use of the heatable seat assembly.

In some examples, the computing system may obtain, for each of the heatable seat assemblies, a power source charge status of the corresponding power source system. The power source charge status may be received from each of the seat controllers and/or determined from heating time of each of the heating systems.

As previously explained, the computer-implemented method may be employed to control a plurality of outdoor heatable seat assemblies. In further examples, the computer-implemented method is employed to control a plurality of indoor heatable seat assembly, e.g. according to the heatable seat assembly of FIG. 10.

FIG. 10 schematically represents an exploded view of a heatable seat assembly 100 according to an example of the present disclosure. As in the heatable seat assembly 100 of FIG. 1, the heatable seat assembly 100 of this example comprises a cover 20 attached to the seat 10. The cover lower surface 22 of this example comprises a cavity receiving the power source system 50. In this figure, the cover lower surface 22 comprises a pair of grooves 24, 25 to receive a pair of bars 62, 63 of the connecting portion 61 of the support structure 60. The connection of the support structure to the seat may be according to any of the examples herein disclosed.

In this example, a bracket 65 is connected to the connecting portion 61, e.g. to the bars 62, 63. In this figure, the bracket 65 is rotatably connected to the base 64. The base 64 is configured to be arranged on the floor. In this example, the base 64 comprises a plurality of wheels arranged at the end of radial arms that extend from a central column 67. This central column 67 is connected to the base 64 through a bearing element that allows the rotation of the central column 67 of the supporting structure about the base 64. A mounting fixture 66 is attached to upper end of the central column 67. The mounting fixture 66 may be connected, e.g. screwed, to the bracket 65. This type of supporting structure may be selected for heatable seat assemblies to be used in indoor zones, e.g. in offices.

For reasons of completeness, various aspects of the present disclosure are set out in the following numbered clauses:

Clause 1: A heatable seat assembly comprising:
a seat having a seat upper surface and a seat lower surface;
a support structure supporting the seat;
a cover attached to the seat, the cover comprising a cover upper surface and a cover lower surface, wherein the cover upper surface faces the seat lower surface;
a heating system to heat the seat, wherein the heating system is arranged between the seat lower surface and the cover upper surface;
a seat controller to control the temperature of the heating system;
a detachable power source system to supply power to the heating system, wherein the detachable power source system comprises a power source and a power source housing holding the power source; and
wherein the cover lower surface comprises a cavity to receive the power source housing.

Clause 2: A heatable seat assembly according to clause 1, wherein the cavity of the cover lower surface comprises a recess to receive a protrusion of the power source housing.

Clause 3: A heatable seat assembly according to clause 2, wherein the power source housing comprises a first side having a tab element, wherein the tab element is configured to apply a pressure against a portion of a wall of the cavity of the cover lower surface or to engage an indentation of a wall of the cavity of the cover lower surface.

Clause 4: A heatable seat assembly according to clause 3, wherein the protrusion protrudes from a second side of the power source housing.

Clause 5: A heatable seat assembly according to clause 4, wherein the first side and the second side are arranged at opposite sides of the power source housing.

Clause 6: A heatable seat assembly according to any of clauses 3-5, wherein the power source housing comprises a lever to control the movement of the tab element relative to the portion of the wall of the cavity of the cover lower surface.

Clause 7: A heatable seat assembly according to any of clauses 3-6, wherein the power source housing is configured to tilt about the recess of the cavity.

Clause 8: A heatable seat assembly according to clause 2, wherein the power source housing is configured to slide within a portion of the cavity.

Clause 9. A heatable seat assembly according to clause 8, wherein power source housing comprises a pair of protrusions, each of them protruding from opposite sides of the power source housing.

Clause 10: A heatable seat assembly according to clause 9, wherein the cavity of the cover lower surface comprises a pair of recesses, each of the pair of recesses arranged at opposite sides of the cavity, wherein each of the pair recesses is configured to receive the corresponding protrusion of the power source housing.

Clause 11: A heatable seat assembly according to any of clauses 1-10, further comprising a locking mechanism to lock the power source housing onto the cavity of the cover.

Clause 12: A heatable seat assembly according to clause 11, wherein the locking mechanism comprises a locking pin configured to be moved from a locking position to an unlocking position and a driving system to move the locking pin.

Clause 13: A heatable seat assembly according to clause 12, wherein the driving system comprises an electromagnet to selectively apply a magnetic force to the locking pin.

Clause 14. A heatable seat assembly according to clause 11-13, wherein the seat controller is configured to control a movement of the locking pin.

Clause 15: A heatable seat assembly according to clause 14, wherein the controller is configured to receive an instruction for unlocking the power source housing and to instruct the driving system to drive the locking pin.

Clause 16: A heatable seat assembly according to any of clauses 11-15, wherein the cover comprises the locking pin configured to engage and disengage a locking hole arranged on the power source housing for locking the power source onto the seat.

Clause 17: A heatable seat assembly according to any of clauses 11-15, wherein the power source housing comprises the locking pin configured to engage and disengage a locking hole arranged on the cover for locking the power source onto the seat.

Clause 18: A heatable seat assembly according to any of clauses 1-17, wherein the cover lower surface comprises a groove and the support structure comprises a connecting portion engaging the groove.

Clause 19: A heatable seat assembly according to clause 18, wherein the connecting portion comprises a pair of bars.

Clause 20: A heatable seat assembly according to any of clauses 18-19, wherein the support structure comprises:
a bracket connected to the connecting portion; and
a base rotatably connected to the bracket, the base being configured to be arranged on the floor.

Clause 21: A heatable seat assembly according to any of clauses 18-20, wherein a fastener connects the connecting portion of the support structure to the seat through the cover.

Clause 22: A heatable seat assembly according to any of clauses 1-21, wherein the seat and/or the cover are made from a plastic material, optionally from an injection molded plastic material.

Clause 23: A heatable seat assembly according to any of clauses 1-22, wherein the seat is made from metal, optionally from aluminium.

Clause 24: A heatable seat assembly according to any of clauses 1-23, wherein the heating system comprises a flexible heating mat.

Clause 25: A heatable seat assembly according to any of clauses 1-24, wherein the heatable seat assembly comprises a temperature sensor to obtain the temperature of the seat upper surface.

Clause 26: A heatable seat assembly according to any of clauses 1-25, wherein the power source is configured to supply a pulse modulated power.

Clause 27: A heatable seat assembly according to clause 26, wherein the pulse modulated power is a pulse width modulated power.

Clause 28: A heatable seat assembly according to any of clauses 1-27, wherein the seat controller is configured to regulate the power supplied by the power source to the heating system.

Clause 29: A heatable seat assembly according to clause 28, wherein the seat controller is further configured to obtain an indication of the temperature of the seat upper surface.

Clause 30: A heatable seat assembly according to clause 29, wherein the seat controller is further configured to send the indication of the temperature of the seat upper surface to a computing system.

Clause 31: A heatable seat assembly according to any of clauses 28-30, wherein heatable seat assembly comprises a temperature selector and wherein the seat controller is further configured to:
receive a temperature setpoint from the temperature selector; and
send the temperature setpoint to a computing system.

Clause 32: A heatable seat assembly according to any of clauses 28-31, wherein the seat controller is configured to receive, from a computing system, a power pattern to be supplied by the power source to the heating system.

Clause 33: A heatable seat assembly according to any of clauses 28-31, wherein the seat controller is further configured to:
receive a temperature setpoint;
determine, based on the temperature setpoint and on the indication of the temperature of the seat upper surface, a power pattern to be supplied by the power source to the heating system.

Clause 34: A heatable seat assembly according to clause 33, wherein the heatable seat assembly comprises a temperature selector and wherein the seat controller is further configured to receive the temperature setpoint from the temperature selector.

Clause 35: A heatable seat assembly according to any of clauses 33-34, wherein the seat controller is configured to receive the temperature setpoint from a computing system.

Clause 36: A heatable seat assembly according to any of clauses 33-35, wherein the seat controller is further configured to:
set, based on the temperature setpoint, an upper temperature setpoint limit and a lower temperature setpoint limit; and
adjust a power pattern to maintain the temperature of the seat upper surface between the upper temperature setpoint limit and the lower temperature setpoint limit.

Clause 37: A heatable seat assembly according to clause 36, wherein to adjust the power pattern comprises to adjust a width of a pulse width modulated power.

Clause 38: A heatable seat assembly according to any of clauses 1-37, wherein the seat controller is configured to determine a seat occupancy.

Clause 39: A heatable seat assembly according to clause 38, wherein to determine the seat occupancy comprises to:
obtain a temperature variation of the temperature of the seat upper surface during a predetermined period of time; and
compare the obtained temperature variation with a predetermined temperature variation.

Clause 40: A heatable seat assembly according to any of clauses 38-39, wherein the seat controller is configured to send to a computing system an indication of the seat occupancy.

Clause 41: A heatable seat assembly according to any of clauses 38-40, wherein the seat controller is further configured to determine a seat occupancy time, and optionally to send the seat occupancy time to a computing system.

Clause 42: A heatable seat assembly according to any of clauses 1-41, wherein the seat controller is further configured to determine a heating time of the heating system, and optionally to send the heating time to a computing system.

Clause 43: A heatable seat assembly according to any of clauses 1-42, wherein the seat controller is further configured to obtain a power source charge status, and optionally to send the power source charge status to a computing system.

Clause 44: A heatable seat assembly according to any of clauses 1-43, wherein the heatable seat assembly is an outdoor heatable seat assembly.

Clause 45: A computer-implemented method comprising:
receiving, from a seat controller of a plurality of heatable seat assemblies, an indication of the temperature of a seat upper surface of a seat of each of the plurality of heatable seat assemblies;
obtaining a temperature setpoint for each of the plurality of heatable seat assemblies;
determining, for each of the plurality of heatable seat assemblies, a power pattern to be supplied by a power source to a heating system of each of the plurality of heatable seat assemblies, wherein determining the power pattern to be supplied by the power source to the heating system is based on the corresponding temperature setpoint and on the indication of the temperature of the seat upper surface; and
sending the corresponding power pattern to the seat controller of each of the plurality of the heatable seat assemblies.

Clause 46: A computer-implemented method according to clause 45, wherein the plurality of heatable seat assemblies is according to any of clauses 1-32 or 44.

Clause 47: A computer-implemented method according to any of clauses 45-46, wherein obtaining the temperature setpoint for each of the plurality of heatable seat assemblies comprises receiving the temperature setpoint from a temperature selector of the corresponding heatable seat assembly of the plurality of heatable seat assemblies.

Clause 48: A computer-implemented method according to any of clauses 45-46, wherein obtaining the temperature setpoint for each of the plurality of heatable seat assemblies comprises receiving the corresponding temperature setpoint from a user interface device remote from the plurality of the heatable seat assemblies.

Clause 49: A computer-implemented method according to any of clauses 45-48, further comprising:
setting, based on the temperature setpoint, an upper temperature setpoint limit and a lower temperature setpoint limit for each of the plurality of heatable seat assemblies;
determining, for each of the plurality of heatable seat assemblies, a power pattern to maintain the temperature of the seat upper surface between the upper temperature setpoint limit and the lower temperature setpoint limit;
sending the width of the pulse width modulated power to the corresponding seat controller of the plurality of heatable seat assemblies.

Clause 50: A computer-implemented method according to clause 49, wherein determining, for each of the plurality of heatable seat assemblies the power pattern comprises calculating, for each of the plurality of heatable seat assemblies, a width of a pulse width modulated power.

Clause 51: A computer-implemented method according to any of clauses 44-50, further comprising determining a seat occupancy for each of the plurality of heatable seat assemblies.

Clause 52: A computer-implemented method according to clause 51, wherein determining the seat occupancy for each of the plurality of heatable seat assemblies comprises:
obtaining, for each of the plurality of heatable seat assemblies, a temperature variation of the temperature of the seat upper surface during a predetermined period of time; and
comparing, for each of the plurality of heatable seat assemblies, the obtained temperature variation with a predetermined temperature variation.

Clause 53: A computer-implemented method according to clause 51, further comprising receiving the seat occupancy for each of the plurality of heatable seat assemblies from the corresponding seat controller.

Clause 54: A computer-implemented method according to any of clauses 51-53, further comprising determining, for each of the plurality of heatable seat assemblies, a seat occupancy time.

Clause 55: A computer-implemented method according to clause 54, further comprising determining, for each of the plurality of heatable seat assemblies, a heating time of the heating system.

Clause 56: A computer-implemented method according to any of clauses 45-55, further comprising obtaining, for each of the plurality of heatable seat assemblies, a power source charge status.

Clause 57: A computer-implemented method according to any of clauses 45-56, further comprising activating one or more of the heatable seat assemblies of the plurality of heatable seat assemblies.

Clause 58: A computer-implemented method according to clause 57, wherein activating one or more of the heatable seat assemblies of the plurality of heatable seat assemblies comprises instructing the seat controller to turn on the heating system.

Clause 59: A computer-implemented method according to any of clauses 57-58, wherein activating one or more of the heatable seat assemblies of the plurality of heatable seat assemblies comprises obtaining an indication to activate the one or more heatable seat assemblies.

Clause 60: A computing system comprising a processor configured to perform the method of any of clauses 45-59.

Clause 61: A computing program comprising instructions, which, when the program is executed by a processor, cause the processor to carry out the method of any of clauses 45-59.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the clauses that follow.

What is claimed is:

1-15. (canceled)

16. An outdoor heatable seat assembly comprising:
a seat having a seat upper surface and a seat lower surface, wherein the seat upper surface is configured to face a body's user when a user is seated on the outdoor heatable seat assembly;
a support structure supporting the seat and configured to rest on a floor;
a cover attached to the seat, the cover comprising a cover upper surface and a cover lower surface, wherein the cover upper surface faces the seat lower surface and wherein the cover lower surface is configured to face the floor when the user is seated on the outdoor heatable seat assembly;
a heating system to heat the seat, wherein the heating system is arranged between the seat lower surface and the cover upper surface;
a seat controller to control the temperature of the heating system;
a detachable power source system to supply power to the heating system, wherein the detachable power source system comprises a power source and a power source housing holding the power source; and
wherein the cover lower surface comprises a cavity to receive the power source housing.

17. The outdoor heatable seat assembly according to claim 16, wherein the power source housing is configured to slide within a portion of the cavity.

18. The outdoor heatable seat assembly according to claim 16, wherein the seat is made from a metal.

19. The outdoor heatable seat assembly according to claim 16, wherein the cover is made from a plastic material, optionally from an injection molded plastic material.

20. The outdoor heatable seat assembly according to claim 16, wherein the seat controller is configured to regulate a power supplied by the power source to the heating system.

21. The outdoor heatable seat assembly according to claim 20, wherein the seat controller is further configured to obtain an indication of the temperature of the seat upper surface.

22. The outdoor heatable seat assembly according to claim 21, wherein the seat controller is further configured to:
receive a temperature setpoint; and
determine, based on the temperature setpoint and on the indication of the temperature of the seat upper surface, a power pattern to be supplied by the power source to the heating system.

23. The outdoor heatable seat assembly according to claim 22, wherein the heatable seat assembly comprises a temperature selector and wherein the seat controller is further configured to receive the temperature setpoint from the temperature selector.

24. The heatable seat assembly according to claim 22, wherein the seat controller is configured to receive the temperature setpoint from a computing system.

25. The outdoor heatable seat assembly according to claim 20, wherein the outdoor heatable seat assembly comprises a temperature selector and wherein the seat controller is further configured to:
receive a temperature setpoint from the temperature selector,
send the temperature setpoint to a computing system.

26. The outdoor heatable seat assembly according to claim 16, further comprising a locking mechanism to lock the power source system into the cavity of the cover.

27. The outdoor heatable seat assembly according to claim 26, wherein the locking mechanism comprises a locking pin configured to be moved from a locking position to an unlocking position and a driving system to move the locking pin.

28. The outdoor heatable seat assembly according to claim 27, wherein the seat controller is configured to control a movement of the locking pin.

29. The outdoor heatable seat assembly according to claim 28, wherein the controller is configured to receive an instruction for unlocking the power source housing and to instruct the driving system to drive the locking pin.

30. The outdoor heatable seat assembly according to claim 16, wherein the seat controller is arranged within the power source housing.

31. A computer implemented method comprising:
receiving, from a seat controller of a plurality of heatable seat assemblies, an indication of the temperature of a seat upper surface of a seat of each of the plurality of heatable seat assemblies;
obtaining a temperature setpoint for each of the plurality of heatable seat assemblies;
determining, for each of the plurality of heatable seat assemblies, a power pattern to be supplied by a power source to a heating system of each of the plurality of heatable seat assemblies, wherein determining the power pattern to be supplied by the power source to the heating system is based on the corresponding temperature setpoint and on the indication of the temperature of the seat upper surface; and
sending the corresponding power pattern to the seat controller of each of the plurality of the heatable seat assemblies.

32. The computer-implemented method according to claim 31, further comprising determining a seat occupancy for each of the plurality of heatable seat assemblies.

33. The computer-implemented method according to claim 32, further comprising determining, for each of the plurality of heatable seat assemblies, a seat occupancy time.

34. A computer-implemented method according to claim 32, further comprising obtaining, for each of the plurality of heatable seat assemblies, a heating time of the heating system and/or a power source charge status.

35. An outdoor heatable seat assembly comprising:
a seat having a seat upper surface and a seat lower surface, wherein the seat upper surface is configured to face a body's user when a user is seated on the outdoor heatable seat assembly;
a support structure supporting the seat and configured to rest on a floor;
a cover attached to the seat, the cover comprising a cover upper surface and a cover lower surface, wherein the cover upper surface faces the seat lower surface and wherein the cover lower surface is configured to face the floor when the user is seated on the outdoor heatable seat assembly;
a heating system to heat the seat, wherein the heating system is arranged between the seat lower surface and the cover upper surface;
a detachable power source system to supply power to the heating system, wherein the detachable power source system comprises a power source and a power source housing holding the power source; and
a seat controller arranged within the power source housing to control the temperature of the heating system;
wherein the cover lower surface comprises a cavity to receive the power source housing; and
a locking mechanism to lock the power source housing into the cavity of the cover.
